(19) United States
(12) Patent Application Publication
(10) Pub. No.: US 2015/0139468 A1
(43) Pub. Date: May 21, 2015

(54) METHOD FOR OPERATING A HEARING DEVICE AS WELL AS A HEARING DEVICE

(71) Applicants: Manuela Feilner, Herrliberg (CH); Hilmar Meier, Zurich (CH)

(72) Inventors: Manuela Feilner, Herrliberg (CH); Hilmar Meier, Zurich (CH)

(73) Assignee: PHONAK AG, Stafa (CH)

(21) Appl. No.: 14/401,293

(22) PCT Filed: May 15, 2012
(86) PCT No.: PCT/EP2012/059016

§ 371 Date: Nov. 14, 2014

(51) Int. Cl. H04R 1/10

(52) U.S. Cl. CPC H04R 1/10; H04R 2430/00
USPC 381/370

(57) ABSTRACT

A hearing device includes at least one input transducer for generating an input signal, an output transducer for generating an output signal and a signal processing unit operationally interconnecting the input transducer and the output transducer. A method includes receiving context information describing a possible current acoustic situation and selecting an adjustment scheme taking into account the context information. The adjustment scheme is one of the following: predefined adjustment scheme, and scenario dependent adjustment scheme comprising at least two scenario adjustments (S₁, . . . , Sₙ), each being assigned at least one hearing program (P₁, . . . , Pₘ). The method also includes selecting a hearing program (P₁, . . . , Pₘ) based on the selected adjustment scheme, and processing the input signal by applying the selected hearing program (P₁, . . . , Pₘ) to obtain the output signal of the hearing device.

### TECHNICAL FIELD OF THE INVENTION

The present invention is related to a method for operating a hearing device as well as to a hearing device.

### DESCRIPTION OF THE RELATED ART

Today's hearing devices very often comprise an automatic control that is operated in dependence on a current acoustic situation analyzed by a classifier in order that the automatic control can adjust processing of an input signal recorded by a microphone. Due to the changing characteristics of the acoustic situation a hearing device user is confronted with, the automatic control of actuators (such as beam former, noise canceller) must adapt to these changing acoustic situation accordingly. The adaptation is solved in two ways: First, it has been proposed to automatically control the actuators independently. Furthermore, it has been proposed to adjust the hearing device according to sound classes, whereas the sound classes represent different acoustic situations. For example, state-of-the art hearing devices comprise four classes, e.g. “Clean Speech”, Speech in Noise”, “Noise” and “Music”.

A specific known teaching is disclosed by EP-1 326 478 A2, in which acoustic signals from the acoustic surrounding are evaluated and direction of arrival of such signals is determined. From signals indicative of such direction of arrival a histogram is formed. The behavior of such histogram is classified under different aspects or criteria and dependent on classification results in a classifying unit, the hearing device and thereby especially its signal transfer characteristics from input acoustic signals to output mechanical signals is controlled or adjusted.

Furthermore, reference is made to the teachings of EP-1 858 291 B1, EP-1 420 611 B1, EP-1 453 356 A2 and EP-1 601 232 B1.

The more effective the known actuators are, the more precise the actuator control needs to be. In addition, with state-of-the art signal processing methods, it is difficult to realize an actuator, e.g. speech enhancement, improving intelligibility in all situations.

Therefore, it is an object of the present invention to improve the adjustment of a hearing device in order to better adapt to a prevailing acoustic situation.

### SUMMARY OF THE INVENTION

The present invention is first directed to a method for operating a hearing device comprising at least one input transducer for generating an input signal, an output transducer for generating an output signal and a signal processing unit operationally interconnecting the input transducer and the output transducer. The method comprises the steps of:
receiving context information describing a possible current acoustic situation, for example, the context information being manually provided or automatically generated,
selecting an adjustment scheme taking into account the context information, the adjustment scheme being one of the following:
   predefined adjustment scheme,
   scenario dependent adjustment scheme comprising at least two scenario adjustments, each being assigned at least one hearing program,
selecting a hearing program based on the selected adjustment scheme, and
processing the input signal by applying the selected hearing program to obtain the output signal of the hearing device.

The present invention provides a classification with a finer grid of detectable acoustic scenes and more accurate means to separate those acoustic scenes from each other. An adjustment of the hearing device is not only based on the audio signal but also based on context information, which allows to adjust parameters of a hearing device more precisely.

An embodiment of the method according to the present invention further comprises the steps of:
analyzing a current acoustic situation by processing the input signal, and
adapting parameters of the selected hearing program based on the current acoustic situation before applying the selected hearing program to the input signal.

Further embodiments of the method according to the present invention further comprise the steps of:
comparing the current acoustic situation with the possible acoustic situation provided in the context information,
selecting the predefined adjustment scheme if the current acoustic situation does not correspond to the possible acoustic situation of the context information, and
selecting the scenario dependent adjustment scheme if the current acoustic situation corresponds to the possible acoustic situation of the context information.

In further embodiments of the method according to the present invention, the predefined adjustment scheme is a single adjustment scheme that is dependent on a user group to which a hearing device user mostly wearing the hearing device belongs.

In further embodiments of the method according to the present invention, the scenario dependent adjustment scheme cover a multitude of specific acoustic scenarios that a hearing device user may encounter while wearing the hearing device.

In further embodiments of the method according to the present invention, a current acoustic scenario is defined by the context information.

Further embodiments of the method according to the present invention further comprise the step of selecting the input signal from a multitude of input transducers on the basis of the context information or on the basis of the adjustment scheme.

In still further embodiments of the method according to the present invention, the context information comprises at least one of the following:
present position, e.g. via Global Positioning System or GPS;
personal calendar with indications on activities of the hearing device user.

In further embodiments of the method according to the present invention, each scenario adjustment comprises a subset of all possible hearing programs.

Furthermore, the present invention is directed to a hearing device comprising:
at least one input transducer for generating an input signal,
an output transducer for generating an output signal;
a signal processing unit operationally interconnecting the input transducer and the output transducer, the signal processing unit being capable of processing the input signal to obtain the output signal of the hearing device,
means for receiving context information describing a possible current acoustic situation,
means for selecting an adjustment scheme taking into account the context information, the adjustment scheme being one of the following:
   predefined adjustment scheme,
   scenario dependent adjustment scheme comprising at least two scenario adjustments, each being assigned at least one hearing program, and
means for selecting a hearing program based on the selected adjustment scheme, the hearing program defining the processing of the input signal in the signal processing unit.

An embodiment of the hearing device according to the present invention further comprises:
means for analyzing a current acoustic situation by processing the input signal, and
means for adapting parameters of the selected hearing program based on the current acoustic situation before applying the selected hearing program to the input signal.

Further embodiments of the hearing device according to the present invention further comprise:
means for comparing the current acoustic situation with the possible acoustic situation provided in the context information,
means for selecting the predefined adjustment scheme if the current acoustic situation does not correspond to the possible acoustic situation of the context information, and
means for selecting the scenario dependent adjustment scheme if the current acoustic situation corresponds to the possible acoustic situation of the context information.

In further embodiments of the hearing device according to the present invention the predefined adjustment scheme is a single adjustment scheme that is dependent on a user group to which a hearing device user mostly wearing the hearing device belongs. A user group may be, for example, a group of pupils of a school for hearing impaired.

In further embodiments of the hearing device according to the present invention the scenario dependent adjustment scheme cover a multitude of specific acoustic scenarios that a hearing device user may encounter while wearing the hearing device.

In further embodiments of the hearing device according to the present invention a current acoustic scenario is defined by the context information.

Further embodiments of the hearing device according to the present invention further comprise means for selecting the input signal from a multitude of input transducers on the basis of the context information or on the basis of the adjustment scheme.

In further embodiments of the hearing device according to the present invention the context information comprises at least one of the following:
present position, e.g. via Global Positioning System or GPS;
personal calendar with indications on activities of the hearing device user.

In further embodiments of the hearing device according to the present invention, each scenario adjustment comprises a subset of all possible hearing programs.

It is pointed out that any combination of the above-mentioned embodiments or combinations of combinations are possible and herewith disclosed. Only those combinations are excluded that would otherwise result in a contradiction.

### BRIEF DESCRIPTION OF THE DRAWINGS

Embodiments of the present invention are hereinafter described by way of example referring to the following drawings.

FIG. 1 shows a hearing device and its components, and

FIG. 2 shows a flow chart describing signal flow and decision making according to the present invention.

### DETAILED DESCRIPTION OF THE PRESENT INVENTION

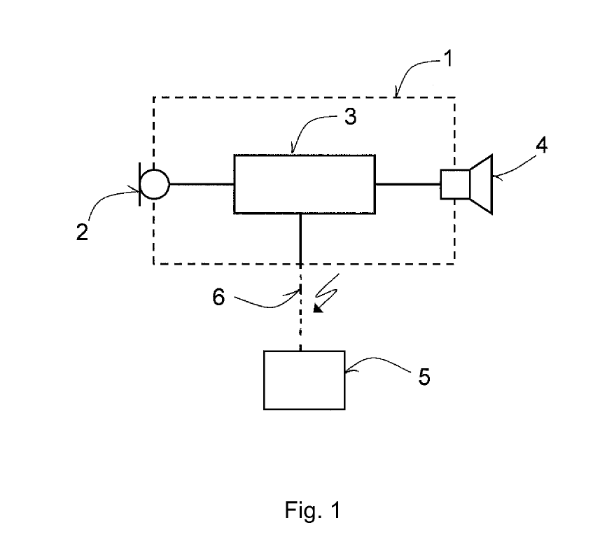

FIG. 1 shows a hearing device 1 comprising an input transducer 2 for receiving an acoustic input signal, an output transducer 4 for generating an acoustic output signal and a signal processing unit 3 operationally interconnecting the input transducer 2 and the output transducer 4. The input transducer 2 is, for example, a microphone for converting an acoustic signal into an electrical signal. The output transducer 4 is a loudspeaker, also called receiver in the field of hearing devices, for converting an electrical signal from the signal processing unit 3 into an acoustic signal that is fed into the ear canal of a hearing device user. The hearing device 1 may be an ITE—(In-the-Ear), a BTE—(Behind-the-Ear), an ITC—(In-the-Canal) or a CIC—(Completely-in-the-Canal)-hearing device. In addition, at least parts of the hearing device may be implantable; in particular the output transducer may be any kind of actuator for actuating the ear drum or its components. In other embodiments of implantable hearing devices, the output transducer is directly stimulating the auditory nervous system. Therefore, the term “hearing device” must be understood as any device, as outlined above, for improving or restoring the hearing of a hearing impaired person.

In FIG. 1, an alternative input transducer 5 is depicted for illustrating a further embodiment of the present invention. The alternative input transducer 5 may be, for example, a remote microphone or another sound source, such as a television set or stereo equipment. An output signal of the alternative input transducer 5 is transmitted via a wired or wireless connection 6 to the hearing device 1. As a result, two input signals are available in the hearing device 1 for processing in the signal processing unit 3. According to this embodiment of the present invention, either the output signal of the input transducer 2 or the signal of the alternative input transducer 5 is selected as the input signal of the signal processing unit 3. Accordingly, only one of the two signals is selected for further processing. The decision which signal is processed by the signal processing unit 3 is determined on the basis of context information that is yet to be described.

In a further embodiment of the present invention, also a mixing of the output signal of the input transducer 5 and the signal of the alternative input transducer 5 is fed to the signal processing unit 3. Accordingly, a mixing of the two signals is selected for further processing. Again, the decision regarding the contribution of each signal is determined on the basis of context information that is yet to be described.

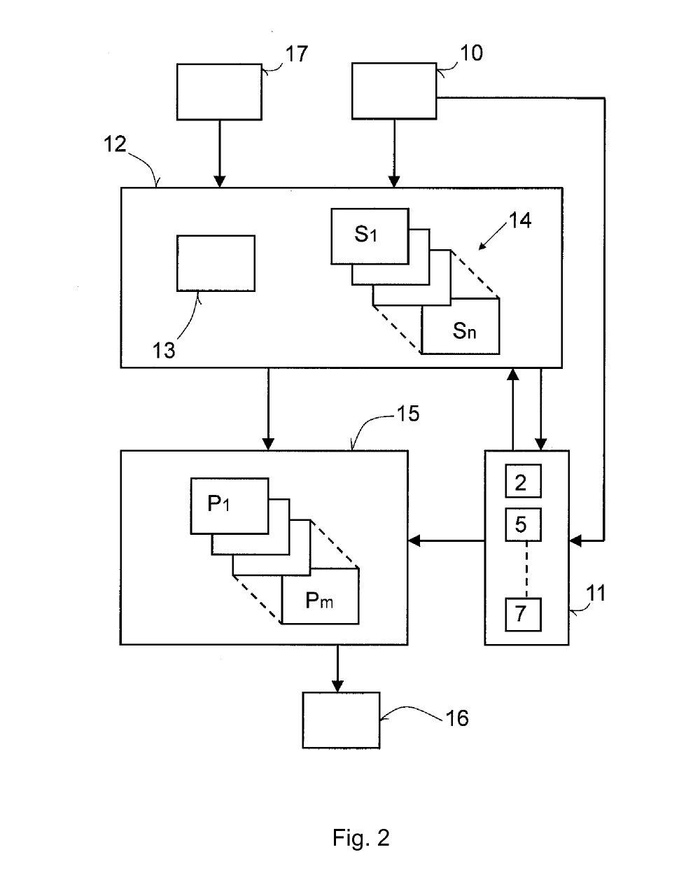

FIG. 2 shows a flow chart illustrating decision layers and signal processing schemes according to one embodiment of the present invention. In general, the present invention is an automatic system for adjusting the hearing device 1 (FIG. 1) to a current acoustic situation.

In order to adjust a hearing device 1 to a current acoustic situation, it is proposed to provide context information 10 for the automatic system. Context information 10 is apriori knowledge of an occurring acoustic situation. The context information 10 is used to expedite and to improve the adaptation of the hearing device 1 to the current acoustic situation.

The context information 10 is used, in a first step, to choose between a predefined adjustment scheme 13 and a scenario dependent adjustment scheme 14 comprised in a scenario block 12. The predefined adjustment scheme 13 is not altered during regular operation of the hearing device. In addition, only one predefined adjustment scheme 13 is stored in the hearing device 1. However, the audiologist adjusting the hearing device 1 to the individual needs of a user has the possibility to set the predefined adjustment scheme 13 during a fitting session, for example by specifying a particular user group, e.g. end-users with severe hearing loss or children, or the like.

The scenario dependent adjustment scheme 14 comprises n different scenario adjustments S₁ to Sₙ of which one is selected on the basis of the context information 10. During regular operation of a hearing device 1, switching between the different scenario adjustments S₁ to Sₙ is common to adapt the signal processing to changing acoustic situations.

The step of selecting one of the adjustment schemes 13 or 14 in the scenario block 12, particular the selection of one of the scenario adjustments S₁ to Sₙ if the scenario dependent selection is selected, will be described at a later stage.

In a further embodiment of the present invention, the input source for the input signal being processed by the signal processing unit 3 is also selected on the basis of the context information 10. This is illustrated by a selection block 11, in which one of the following input sources is selected for generating the input signal:
input transducer 2, such as an internal microphone of the hearing device 1 (FIG. 1);
alternative input transducer 5, such as a remote microphone transmitting the recorded signal via wire or wirelessly to the hearing device 1 (FIG. 1);
T-coil picking-up a signal of a mobile communication device;
analog input transmitted by wire or transmitted wirelessly (as for example transmitted via a FM-frequency modulation channel);
digital input transmitted by wire or transmitted wirelessly (for example via inductive antenna, Bluetooth, or the like).

Alternatively, one of the mentioned input sources may also be selected on the basis of an adjustment scheme. This embodiment of the present invention is illustrated in FIG. 2 by an arrow from the scenario block 12 to the selection block 11.

After having selected the adjustment scheme (and possibly the input signal), a hearing program is selected in a further step, the selection of the hearing program being based on the selected adjustment scheme. In FIG. 2, a block 15 is depicted comprising m different hearing programs P₁ to Pₘ that comprise themselves different parameter settings. Those parameter settings define a so called “Actuator setting”, wherein an actuator may be, for example, a beam former, a noise canceller, etc. The actuators have a direct influence on the audio output generated by the output transducer 4 of the hearing device 1 (FIG. 1).

In the scenario block 12, the adjustment scheme is selected, one being the predefined adjustment scheme 13, the other being the scenario dependent adjustments scheme 14. The scenario dependent adjustment scheme 14 is an automatic mode for selecting a specific well defined hearing scenario (or acoustic situation) where different hearing activities occur.

The scenario dependent adjustment scheme 13 and the predefined adjustment scheme 13 select one of the available hearing programs P₁ to Pₘ (depicted in block 15 in FIG. 2), or, in a further embodiment of the present invention, a mixture of several of the hearing programs P₁ to Pₘ. The hearing programs P₁ to Pₘ are arranged into two dimensions:

One dimension describing the hearing activity (such as listening to music, background discussion, having a conversation, quiet situation, etc.)

The second dimension describing the acoustic surrounding identified by properties like:
sound shapes:
   room acoustic;
   adverseness;
hearing objects (in focus):
   direction;
   own-voice or speaker;
   which speaker;
surrounding:
   influence on priorities toward hearing activities:
      e.g. orientation, safety vs. listening to a specific object.

In a specific embodiment of the present invention, a scenario dependent adjustment scheme 14 is selected according to the context information 10. Thereafter, the scenario dependent adjustment scheme 14 is running autonomously, i.e. the context information 10 is not needed anymore.

The selected scenario adjustments S₁ to Sₙ in the scenario dependent adjustment scheme 14 selects a hearing program from a reduced set of the hearing programs P₁ to Pₘ that is optimized for the corresponding scenario adjustment S₁ to Sₙ.

Due to the a priori knowledge of the occurring scenes in the scenario dependent adjustment scheme 14, a higher success rate is obtained leading to a higher acceptance of hearing devices. Also the dynamic behavior (switching between hearing programs) can be faster if necessary.

The advantage of using context information 10 to select a scenario can also be described in the reverse way: many hearing programs can be excluded from the detection because these hearing programs are unlikely to occur in the selected scenario. Therefore, there is no need taking into account these hearing programs resulting in a decrease of the error rate for the classification.

Therefore, a further embodiment of the present invention further comprises the step of limiting or reducing the number of possible hearing programs P₁ to Pₘ to a subset of hearing programs belonging to a corresponding scenario.

In a still further embodiment of the present invention, each adjustment scheme 12 can only select from a subset of all possible hearing programs P₁ to Pₘ. In addition, it is also feasible that the predefined adjustment scheme 13 either selects from a subset of all possible hearing programs P₁ to Pₘ or selects from all possible hearing programs P₁ to Pₘ.

Furthermore, a hearing program P₁ to Pₘ can be coupled to specific input transducers resulting in automatically using said hearing program P₁ to Pₘ as soon as the specific input transducer is active.

In a further embodiment of the present invention, a manual control 17 is provided via which an adjustment scheme is manually selectable.

The present invention can be also used for hearing device users with specific needs or in different product segments in a specific situation, e.g. end-users with severe hearing loss having a conversation, children at school, bedridden older end-users being conducted in a wheel chair, etc. This is also valid for CI-users. Product lines can be tailored to encountered and possible scenarios and its corresponding hearing programs. This is valid for a predefined adjustments scheme as well as for a scenario dependent adjustment scheme using context information, as for example:
playground, school or sport scenarios for children;
visit of a medical doctor or bed rest for people needing care (e.g. detection the scenario when a person's head is lying on an ear).

It has already been pointed out that the hearing device 1 comprises a predefined adjustment scheme 13 and a scenario dependent adjustment scheme 14 providing a number of scenario adjustments S₁ to Sₙ. These scenario dependent adjustments S₁ to Sₙ—also called “modes”—can be selected manually or automatically. Based on the context information 10, one of the scenario adjustments S₁ to Sₙ is automatically selected depending on the current hearing scenario. Asymptotically, one could imagine of different programs comprising one parameter set or several parameter sets depending on the hearing scenario. Such a scenario adjustment S₁ to Sₙ can cover acoustic situations like:
“working in an office”: concentrated work versus conversation and phone calls;
“watching TV”: understanding speech versus enjoying music or other sound;
“singing in a choir”: singing versus understanding the instructions of the conductor;
“going into a classical concert”: enjoying music versus applause versus conversation in babble noise;
“car driving”: listening to the car environment versus understanding traffic information updates.

In order to provide a scenario dependent adjustment 14 in a hearing device 1, the program structure should be adapted not to increase complexity unnecessarily or not to run into a data storage problem. Such a structure can be a hierarchical program system with so called “full programs” and so called “subprograms”, where full programs have a full parameter description and a subprogram only has a subset of parameters that can differ from the corresponding parameters of the respective full program. In addition, the programs can be stored in the hearing device in a memory saving way, by saving only the not common parameters of each program and refer to parameters of a so called “Basis-Program”.

The classifiers can be implemented in different ways. One possibility comprises the step of classifying all full programs and subprograms and of masking out the programs selected for a specific scenario adjustment S₁ to Sₙ. Another possibility is a generic classifier whose decisions are determined through coefficients that are assigned to a specific scenario adjustment S₁ to Sₙ. That means each scenario adjustment S₁ to Sₙ has a separate coefficient set which defines the classification output. Those coefficients can be stored as parameters and loaded from a controlling system in the hearing device to the classifier location in the signal processing unit 3 (FIG. 1).

The latter possibility has the advantage of higher generalization and separation of classifiers. Each classifier can be changed and improved without influencing the performance of the other classifiers. In addition, not every scenario adjustment S₁ to Sₙ is needed in every product or for each end-user, and thus unnecessary complexity can be avoided by “applying” only the scenario adjustments S₁ to Sₙ needed for a specific hearing device 1.

In an embodiment of the present invention, two or more classifiers can be implemented in parallel.

In yet another embodiment of the present invention, context information 10 (FIG. 2) is provided by a context finder to the signal processing unit 3 for further processing according to already described procedures.

For example, the context finder may use different sensor modalities to obtain as much context information as possible. Such context sources can be:
A calendar that is synchronized with the hearing device 1 and double checked with the audio signal of the input transducer 2. For example, the calendar can contain the class schedule of a child and change the parameter set depending on the entries in the calendar, such as a pause, music class, sport class or an ex cathedra teaching lesson or others. The calendar can be seen as a carrier of context information. A time shift or spontaneous change of the calendar event can be handled with the analysis of the audio signal of the input transducer 2 or other sensors that carry information about the current possible hearing scenario. This might also be another remote microphone or the like.
Location information (for example obtained by the Global Positioning System or GPS) can carry context information as well. For example, the current location may be identified as a concert hall, a shopping mall, home, train, etc.
An acceleration pick-up unit can be used to detect a certain activity. For example, motion detection can be an indication of sport, in particular if any speech signal is not coming from the front and is typically unimportant.

In a further embodiment of the present invention, a learning algorithm is additionally applied to the context finder. The context finder could learn from the current sensor analysis or from an input of the hearing device user.

The scenario dependent adjustments S₁ to Sₙ are provided to the fitter as a standard or optional manual or automatic program for each end-user dependent on his need and preference. The degree of freedom for fitting the programs of additional scenario dependent adjustments could be:
Full freedom: all parameters are available for fitting.
The fitting is dependent on the related hearing activity program of the predefined adjustment scheme 13. Only a subset of parameters and/or only a limited range per parameter is open to the fitter.

The handling of input signals generated by the alternative input transducer 5 (FIG. 1) can be implemented differently. When an alternative input transducer 5 is selected, several scenarios may apply:
The signal of the alternative input transducer 5 can be classified according to a scenario adjustment S₁ to Sₙ. In doing so, the dependency of the kind of input source is already separated before the classification system. The classification input is than already normalized to the different sources, e.g. T-coil, Bluetooth etc.
No classification of the signal of the alternative input transducer 5 is done, but different programs dependent on the content of the signal are selected.
Different programs are available depending on the input source, but independent of the content of the signal.

What is claimed is:

1. A method for operating a hearing device (1) comprising at least one input transducer (2, 5, 7) for generating an input signal, an output transducer (4) for generating an output signal and a signal processing unit (3) operationally interconnecting the input transducer (2, 5, 7) and the output transducer (4), the method comprising the steps of:
receiving context information (10) describing a possible current acoustic situation,
selecting an adjustment scheme (12, S₁, . . . , Sₘ) taking into account the context information (10), the adjustment scheme (12) being one of the following:
predefined adjustment scheme (13),
scenario dependent adjustment scheme (14) comprising at least two scenario adjustments (S₁, . . . , Sₙ), each being assigned at least one hearing program (P₁, . . . , Pₘ),
selecting a hearing program (P₁, . . . , Pₘ) based on the selected adjustment scheme (12), and
processing the input signal by applying the selected hearing program (P₁, . . . , Pₘ) to obtain the output signal of the hearing device (1).

2. The method of claim 1, further comprising the steps of:
analyzing a current acoustic situation by processing the input signal, and
adapting parameters of the selected hearing program (P₁, . . . , Pₘ) based on the current acoustic situation before applying the selected hearing program (P₁, . . . , Pₘ) to the input signal.

3. The method of claim 1, further comprising the steps of:
comparing the current acoustic situation with the possible acoustic situation provided in the context information (10),
selecting the predefined adjustment scheme (13) if the current acoustic situation does not correspond to the possible acoustic situation of the context information (10), and
selecting the scenario dependent adjustment scheme (14) if the current acoustic situation corresponds to the possible acoustic situation of the context information (10).

4. The method of claim 1, wherein the predefined adjustment scheme (13) is a single adjustment scheme that is dependent on a user group to which a hearing device user mostly wearing the hearing device (1) belongs.

5. The method of claim 1, wherein the scenario dependent adjustment scheme (14) cover a multitude of specific acoustic scenarios that a hearing device user may encounter while wearing the hearing device (1).

6. The method of claim 5, wherein a current acoustic scenario is defined by the context information (10).

7. The method of claim 1, further comprising the step of selecting the input signal from a multitude of input transducers (2, 5, 7) on the basis of the context information (10) or on the basis of the adjustment scheme (12).

8. The method of claim 1, wherein the context information (10) comprises at least one of the following:
present position, e.g. via Global Positioning System or GPS;
personal calendar with indications on activities of the hearing device user.

9. The method of claim 1, wherein each scenario adjustment (S₁, . . . , Sₙ) comprises a subset of all possible hearing programs (P₁, . . . , Pₘ).

10. A hearing device comprising:
at least one input transducer (2, 5, 7) for generating an input signal,
an output transducer (4) for generating an output signal;
a signal processing unit (3) operationally interconnecting the input transducer (2, 5, 7) and the output transducer (4), the signal processing unit (3) being capable of processing the input signal to obtain the output signal of the hearing device (1),
means for receiving context information (10) describing a possible current acoustic situation,
means for selecting an adjustment scheme (12) taking into account the context information (10), the adjustment scheme (12) being one of the following:
predefined adjustment scheme (13),
scenario dependent adjustment scheme (14) comprising at least two scenario adjustments (S₁, . . . , Sₙ), each being assigned at least one hearing program (P₁, . . . , Pₘ), and
means for selecting a hearing program (P₁, . . . , Pₘ) based on the selected adjustment scheme (12), the hearing program (P₁, . . . , Pₘ) defining the processing of the input signal in the signal processing unit (3).

11. The hearing device of claim 10, further comprising:
means for analyzing a current acoustic situation by processing the input signal, and
means for adapting parameters of the selected hearing program (P₁, . . . , Pₘ) based on the current acoustic situation before applying the selected hearing program (P₁, . . . , Pₘ) to the input signal.

12. The hearing device of claim 10, further comprising:
means for comparing the current acoustic situation with the possible acoustic situation provided in the context information (10),
means for selecting the predefined adjustment scheme (13) if the current acoustic situation does not correspond to the possible acoustic situation of the context information (10), and
means for selecting the scenario dependent adjustment scheme (14) if the current acoustic situation corresponds to the possible acoustic situation of the context information (10).

13. The hearing device of claim 10, wherein the predefined adjustment scheme (13) is a single adjustment scheme that is dependent on a user group to which a hearing device user mostly wearing the hearing device (1) belongs.

14. The hearing device of claim 10, wherein the scenario dependent adjustment scheme (14) cover a multitude of specific acoustic scenarios that a hearing device user may encounter while wearing the hearing device (1).

15. The hearing device of claim 14, wherein a current acoustic scenario is defined by the context information (10).

16. The hearing device of claim 10, further comprising means for selecting the input signal from a multitude of input transducers (2, 5, 7) on the basis of the context information (10) or on the basis of the adjustment scheme (12).

17. The hearing device of claim 10, wherein the context information (10) comprises at least one of the following:
present position, e.g. via Global Positioning System or GPS;
personal calendar with indications on activities of the hearing device user.

18. The hearing device of claim 10, wherein each scenario adjustment (S₁, . . . , Sₙ) comprises a subset of all possible hearing programs (P₁, . . . , Pₘ).
